(19) United States
(12) Patent Application Publication
(10) Pub. No.: US 2015/0124199 A1
(43) Pub. Date: May 7, 2015

(54) TRANSPARENT DISPLAY DEVICE

(71) Applicant: Chunghwa Picture Tubes, Ltd., Taoyuan (TW)

(72) Inventors: Chun-Wei SU, New Taipei City (TW); Jian-Hua CHEN, Changhua County (TW)

(73) Assignee: Chunghwa Picture Tubes, Ltd., Taoyuan (TW)

(21) Appl. No.: 14/133,654

(22) Filed: Dec. 19, 2013

(30) Foreign Application Priority Data
Nov. 5, 2013 (TW) 102140125

(51) Int. Cl. G02F 1/1335; H05B 33/08

(52) U.S. Cl. CPC G02F 1/133603; H05B 33/0896; G02F 2001/133612
USPC 349/69

(57) ABSTRACT

A transparent display device includes a display panel and an active transparent OLED backlight device. The display panel includes a first driving substrate, a color filter substrate and a polymer dispersed liquid crystal layer interposed therebetween. The first driving substrate has a first driving region and sub-pixel regions. The active transparent OLED backlight device includes a second driving substrate, an opposite substrate and OLEDs interposed therebetween. The second driving substrate has a second driving region and sub-pixel regions. The second driving region is aligned with the first driving region, and each of the sub-pixel regions of the second driving substrate is aligned with one of the sub-pixel regions of the first driving substrate. Each of the sub-pixel regions of the second driving substrate has a light-transmitting region and a light-emitting region. The OLEDs are respectively disposed on the light-emitting regions of the second driving substrate.

### RELATED APPLICATIONS

This application claims priority to Taiwanese Application Serial Number 102140125, filed Nov. 5, 2013, which is herein incorporated by reference.

### BACKGROUND

1. Field of invention

The present invention relates to a transparent display device. More particularly, the present invention relates to a transparent display device including a display panel and an active transparent organic light-emitting diode (OLED) backlight device.

2. Description of Related Art

Generally, a liquid crystal display (LCD) device may be generally classified into a transmissive LCD device, a reflective LCD device and a transflective LCD device. With the increasing of display device applications, transparent display devices have gradually been developed. A viewer may see not only an image displayed by the transparent display device but also background information behind the transparent display device, and thus heavy sense of the visual is not generated. Such transparent display device may be used in a vehicle windshield or a showcase.

In current transparent display devices, lights for displaying an image are typically derived from ambient lights and a backlight module. A common approach at present is to use a backlight module including a light source and a light guide plate. However, a pattern of the light guide plate may cause transmittance of the transparent display device decreased. In another aspect, the transparent display device may include a LCD panel and a polarizing plate. Nevertheless, the polarizing plate may also significantly affect transmittance of the transparent display device, and thus a transparent effect cannot be demonstrated. In view of the above, how to enhance transmittance of the transparent display device becomes an important issue.

### SUMMARY

An aspect of the present invention provides a transparent display device including a display panel and an active transparent organic light-emitting diode (OLED) backlight device. The display panel includes a first driving substrate, a color filter substrate and a polymer dispersed liquid crystal (PDLC) layer. The first driving substrate has a first driving region and sub-pixel regions. The color filter substrate is parallel to the first driving substrate. The PDLC layer is interposed between the first driving substrate and the color filter substrate. The active transparent OLED backlight device includes a second driving substrate, an opposite substrate and OLEDs. The second driving substrate has a second driving region and sub-pixel regions. The second driving region is aligned with the first driving region, and each of the sub-pixel regions of the second driving substrate is aligned with one of the sub-pixel regions of the first driving substrate. Each of the sub-pixel regions of the second driving substrate has a light-transmitting region and a light-emitting region. The opposite substrate is parallel to the second driving substrate. The OLEDs are respectively disposed on the light-emitting regions of the second driving substrate and interposed between the light-emitting regions of the second driving substrate and the opposite substrate.

According to one embodiment of the present invention, the light-transmitting region has an area greater than an area of the light-emitting region.

According to one embodiment of the present invention, an area ratio of the light-transmitting region to the light-emitting region is greater than or equal to 7:3.

According to one embodiment of the present invention, the second driving substrate includes an ambient light sensor disposed on the second driving region of the second driving substrate.

According to one embodiment of the present invention, the OLEDs are closed when an ambient light intensity detected by the ambient light sensor is greater than a set value, and the set value is in a range from 200 lux to 300 lux.

According to one embodiment of the present invention, at least one of the OLEDs is opened when an ambient light intensity detected by the ambient light sensor is lower than a set value, and the set value is in a range from 0 lux to 200 lux.

According to one embodiment of the present invention, each of the OLEDs is a white OLED.

According to one embodiment of the present invention, the transparent display device further includes an optical adhesive interposed between the display panel and the active transparent OLED backlight device.

According to one embodiment of the present invention, the optical adhesive contacts a surface of the first driving substrate.

According to one embodiment of the present invention, the transparent display device excludes a polarizing plate.

### BRIEF DESCRIPTION OF THE DRAWINGS

The invention can be more fully understood by reading the following detailed description of the embodiment, with reference made to the accompanying drawings as follows:

FIG. 1 is a cross-sectional view of a transparent display device according to one embodiment of the present invention;

FIG. 2A is a top view of a portion of a first driving substrate according to one embodiment of the present invention;

FIG. 2B is a top view of a portion of a second driving substrate according to one embodiment of the present invention;

FIG. 3A is a cross-sectional view of first and second driving substrates, illustrating when an OLED does not emit light according to one embodiment of the present invention; and

FIG. 3B is a cross-sectional view of first and second driving substrates, illustrating when an OLED emits light according to one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

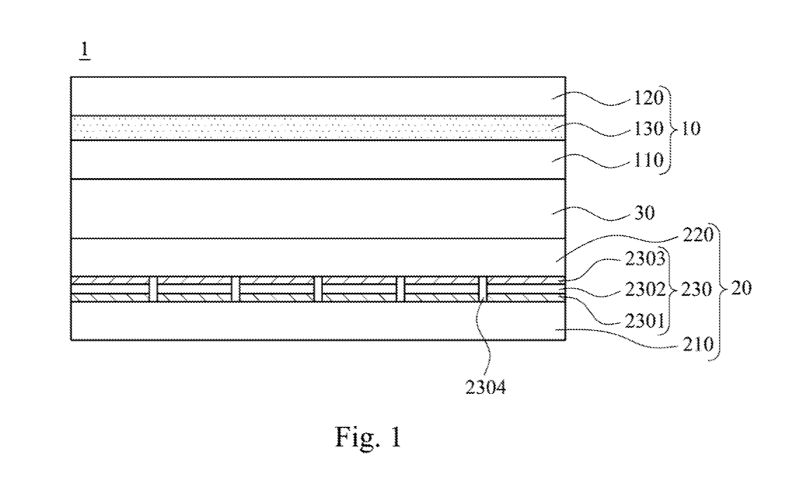

FIG. 1 is a cross-sectional view of a transparent display device 1 according to one embodiment of the present invention. The transparent display device 1 includes a display panel 10 and an active transparent organic light-emitting diode (OLED) backlight device 20.

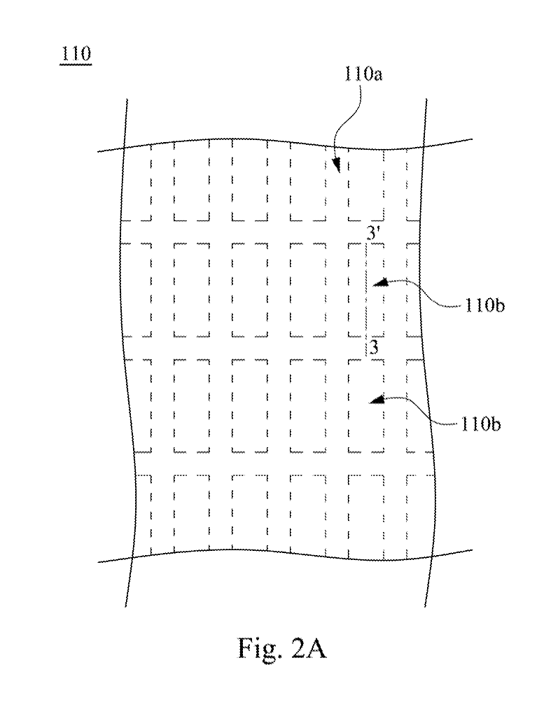

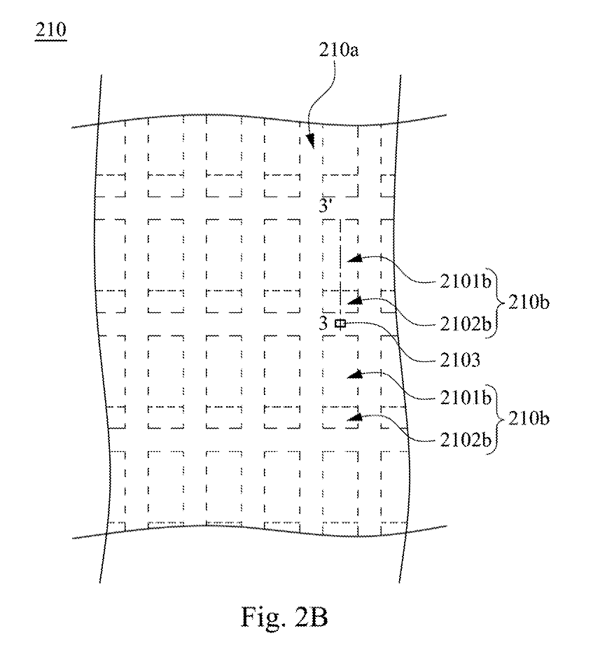

The display panel 10 includes a first driving substrate 110, a color filter substrate 120 and a polymer dispersed liquid crystal (PDLC) layer 130. FIG. 2A is a top view of a portion of the first driving substrate 110 according to one embodiment of this invention. The first driving substrate 110 has a first driving region 110a and a plurality of sub-pixel regions 110b. The first driving substrate 110 may be a thin film transistor array substrate, which may include thin film transistors (not shown), scan lines (not shown) and data lines (not shown) disposed in the first driving region 110a. The scan lines and the data lines may be intersected to define the sub-pixel regions 110b.

The color filter substrate 120 is substantially parallel to the first driving substrate 110. For example, the color filter substrate 120 may include a substrate (not shown), a light shielding structure (not shown), color filter patterns (not shown) and a transparent conductive layer (not shown). Since the PDLC layer 130 is used in the display panel 10 rather than a general liquid crystal layer, there is no need for any orientation structure layer in the color filter substrate 120, so as to save manufacturing and material costs.

The PDLC layer 130 is interposed between the first driving substrate 110 and the color filter substrate 120. The PDLC layer 130 may be prepared by nematic liquid crystals, photopolymerizable materials and a photo initiator. Specifically, the nematic liquid crystals, photopolymerizable materials and photo initiator may be premixed and then irradiated by UV light to form liquid crystal droplets. It is noteworthy that since the PDLC layer 130 is used in the display panel 10 rather than a general liquid crystal layer, there is no need for any polarizing plate. The transparent display device 1 exhibits very high transmittance since it excludes a polarizing plate.

The active transparent OLED backlight device 20 is disposed on a surface of the display panel 10, which includes a second driving substrate 210, an opposite substrate 220 and a plurality of OLEDs 230, as shown in FIG. 1. However, in other embodiments, positions of the second driving substrate 210 and the opposite substrate 220 may be interchanged, and not limited to those exemplified in FIG. 1.

FIG. 2B is a top view of a portion of the second driving substrate 210 according to one embodiment of this invention. The second driving substrate 210 has a second driving region 210a and a plurality of sub-pixel regions 210b. The second driving substrate 210 may be a thin film transistor array substrate, which may include thin film transistors (not shown), scan lines (not shown) and data lines (not shown) disposed in the second driving region 210a. The scan lines and the data lines may be intersected to define the sub-pixel regions 210b. It is noteworthy that the second driving region 210a is substantially aligned with the first driving region 110a, and each of the sub-pixel regions 210b of the second driving substrate 210 is substantially aligned with one of the sub-pixel regions 110b of the first driving substrate 110. In other words, the sub-pixel regions 210b are respectively corresponded to the sub-pixel regions 110b. As shown in FIGS. 2A-2B, an edge of the second driving region 210a may be substantially overlapped with an edge of the first driving region 110a, and an edge of one of the sub-pixel regions 210b may also be substantially overlapped with an edge of the corresponding sub-pixel region 110b.

It is noteworthy that each of the sub-pixel regions 210b of the second driving substrate 210 has a light-transmitting region 2101b and a light-emitting region 2102b. The OLEDs 230 of FIG. 1 are respectively disposed on the light-emitting regions 2102b of the second driving substrate 210 of FIG. 2B. In addition, the OLEDs 230 are interposed between the light-emitting regions 2102b of the second driving substrate 210 and the opposite substrate 220. It is important that the OLEDs 230 are not disposed on the light-transmitting regions 2101b, such that the active transparent OLED backlight device 20 still exhibits high transmittance. For example, no material or a gate insulating layer (not shown) of the thin film transistor may be disposed on the light-transmitting regions 2101b of the second driving substrate 210, but not limited thereto. It is sure that the transparent display device 1 has higher transmittance when no material is disposed on the light-transmitting regions 2101b. Therefore, a viewer may see back information behind the transparent display device 1 through each of the light-transmitting regions 2101b during seeing an image displayed by the display panel 10. Moreover, the skilled in the art should understood that positions of the light-transmitting region 2101b and the light-emitting region 2102b may be appropriately altered and not limited to those exemplified in FIG. 2B.

In one embodiment, the light-transmitting region 2101b has an area greater than an area of the light-emitting region 2102b. The greater the area ratio of the light-transmitting region 2101b to the light-emitting region 2102b, the higher the transmittance of the active transparent OLED backlight device 20. In one embodiment, the area ratio of the light-transmitting region 2101b to the light-emitting region 2102b is greater than or equal to 7:3 in order to let the transparent display device 1 exhibit high transmittance.

In one embodiment, the area ratio of the light-transmitting region 2101b to the light-emitting region 2102b is greater than or equal to 8:2. In one embodiment, the transparent display device 1 has a transmittance greater than or equal to 20% when the area ratio of the light-transmitting region 2101b to the light-emitting region 2102b is greater than or equal to 7:3. A method for measuring transmittance is performed by disposing the transparent display device 1 in a Transmittance Tester (LCD-7200) to measure the transmittance thereof. If the area ratio of the light-transmitting region 2101b to the light-emitting region 2102b is zero (i.e., no light-transmitting region 2101b), transmittance of such transparent display device may be lower than 5%.

Given the above, to dispose the light-transmitting regions 2101b is indeed able to make the transparent display device 1 have very high transmittance.

In another aspect, as shown in FIG. 1, the OLED 230 may include a first electrode 2301, an organic light-emitting layer 2302 and a second electrode 2303. In one embodiment, each of the OLEDs 230 is a white OLED. In other words, each of the organic light-emitting layers 2302 is configured to emit white light. An insulating layer 2304 may be disposed between two adjacent OLEDs 230 to insulate from each other. One of the first and second electrodes 2301, 2303 is an anode, and the other thereof is a cathode. In order to have good interfacial bonding property between the organic light-emitting layer 2302 and the first and second electrodes 2301, 2303, one or more buffer layers may be selectively disposed between the first and second electrodes 2301, 2303. The buffer layer may include an electron injection layer (not shown), a hole injection layer (not shown), an electron transporting layer (not shown), a hole transporting layer (not shown) or a combination thereof, but not limited thereto.

The opposite substrate 220 is substantially parallel to the second driving substrate 210. The opposite substrate 220 may be a single layer glass substrate or a flexible substrate. In one embodiment, substrates of the first driving substrate 110, the color filter substrate 120, the second driving substrate 210 and the opposite substrate 220 are flexible substrates, and the transparent display device 1 becomes a flexible transparent display device. The flexible material may be polyimide, polyethylene terephthalate (PET), polyethylene naphthalate (PEN) or polymethyl methacrylate (PMMA).

Furthermore, as shown in FIG. 1, the transparent display device 1 may further include an optical adhesive 30 interposed between the display panel 10 and the active transparent OLED backlight device 20. The optical adhesive 30 contacts a surface of the first driving substrate 110, which has functions of adhesion and protection.

In one embodiment, as shown in FIG. 2B, an ambient light sensor 2103 is disposed on the second driving region 210a of the second driving substrate 210 in order to let the transparent display device 1 exhibit good visibility in various environments with different light intensities. The ambient light sensor 2103 may recognize light intensity to determine whether the OLEDs are all closed, partially opened and partially closed or all opened.

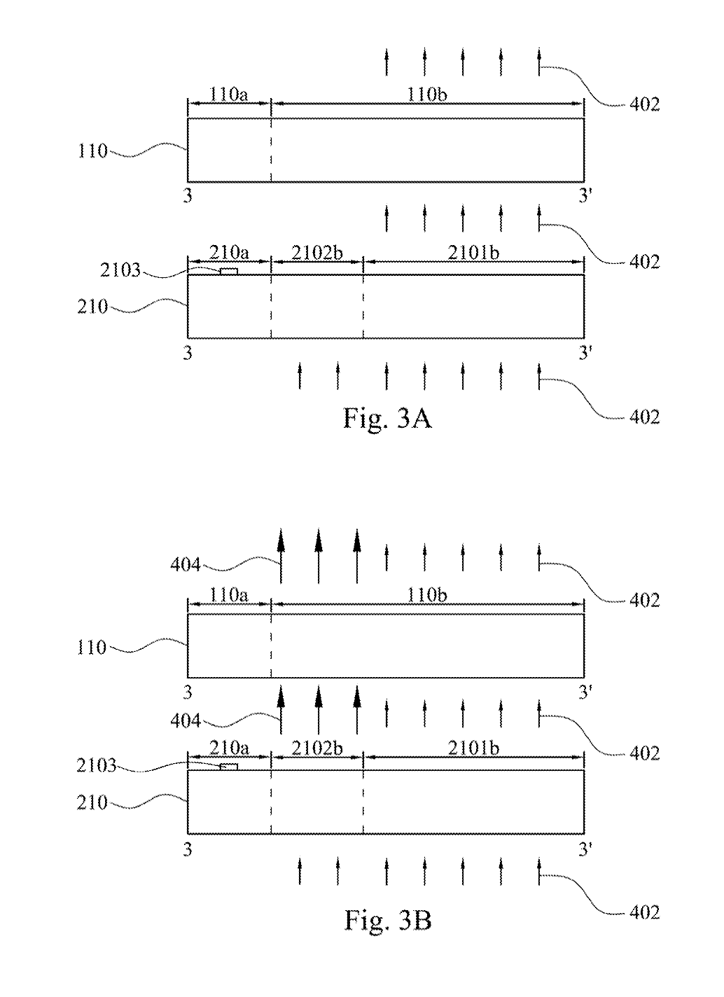

FIGS. 3A-3B are cross-sectional views of first and second driving substrates 110, 210, illustrating respectively when an OLED does not emit light and emits light according to one embodiment of the present invention, which is along a line 3-3′ of FIGS. 2A-2B. In one embodiment, as shown in FIG. 3A, each of the OLEDs is closed when an ambient light intensity detected by the ambient light sensor 2103 is greater than a set value (e.g., under the sunlight or in a bright room) to save power. In this case, a viewer may see an image displayed by ambient lights 402 and back information behind the image. In one embodiment, the set value is in a range from 200 lux to 300 lux. In contrast, as shown in FIG. 38, at least one of the OLEDs is opened when an ambient light intensity detected by the ambient light sensor 2103 is lower than a set value (e.g., at night or in a dark room). In this case, a viewer may see not only an image displayed by ambient lights 402 and lights 404 emitting from the OLED but also back information behind the image. In one embodiment, the set value is in a range from 0 lux to 200 lux. Besides, light intensity of each OLED may be independently controlled, and thus the transparent display device exhibits functionality of dynamic contrast adjustment. As mentioned above, the transparent display device of the present invention exhibits high transmittance whether in any light intensity, and thus the problems faced in the art may be effectively solved.

It will be apparent to those ordinarily skilled in the art that various modifications and variations may be made to the structure of the present invention without departing from the scope or spirit of the invention. In view of the foregoing, it is intended that the present invention cover modifications and variations thereof provided they fall within the scope of the following claims.

What is claimed is:

1. A transparent display device, comprising:
a display panel, comprising:
a first driving substrate having a first driving region and a plurality of sub-pixel regions;
a color filter substrate parallel to the first driving substrate; and
a polymer dispersed liquid crystal layer interposed between the first driving substrate and the color filter substrate; and
an active transparent organic light-emitting diode (OLEO) backlight device disposed on a surface of the display panel, the active transparent OLED backlight device comprising:
a second driving substrate having a second driving region and a plurality of sub-pixel regions, the second driving region aligned with the first driving region, each of the sub-pixel regions of the second driving substrate aligned with one of the sub-pixel regions of the first driving substrate, wherein each of the sub-pixel regions of the second driving substrate has a light-transmitting region and a light-emitting region;
an opposite substrate parallel to the second driving substrate; and
a plurality of OLEDs respectively disposed on the light-emitting regions of the second driving substrate and interposed between the light-emitting regions of the second driving substrate and the opposite substrate.

2. The transparent display device of claim 1, wherein the light-transmitting region has an area greater than an area of the light-emitting region.

3. The transparent display device of claim 1, wherein an area ratio of the light-transmitting region to the light-emitting region is greater than or equal to 7:3.

4. The transparent display device of claim 1, wherein the second driving substrate comprises an ambient light sensor disposed on the second driving region of the second driving substrate.

5. The transparent display device of claim 4, wherein the OLEDs are closed when an ambient light intensity detected by the ambient light sensor is greater than a set value, and the set value is in a range from 200 lux to 300 lux.

6. The transparent display device of claim 4, wherein at least one of the OLEDs is opened when an ambient light intensity detected by the ambient light sensor is lower than a set value, and the set value is in a range from 0 lux to 200 lux.

7. The transparent display device of claim 1, wherein each of the OLEDs is a white OLED.

8. The transparent display device of claim 1, further comprising an optical adhesive interposed between the display panel and the active transparent OLED backlight device.

9. The transparent display device of claim 8, wherein the optical adhesive contacts a surface of the first driving substrate.

10. The transparent display device of claim 1, wherein the transparent display device excludes a polarizing plate.
